(19) United States
(12) Patent Application Publication
(10) Pub. No.: US 2026/0030678 A1
(43) Pub. Date: Jan. 29, 2026

(54) Generative Learning for Financial Time Series with Irregular and Scale-Invariant Patterns

(71) Applicant: City University of Hong Kong, Hong Kong (CN)

(72) Inventors: Minghua CHEN, Hong Kong (CN); Xiao QIAO, Hong Kong (CN); Hongbin HUANG, Hong Kong (CN)

(21) Appl. No.: 18/786,698

(22) Filed: Jul. 29, 2024

(51) Int. Cl. G06Q 40/06

(52) U.S. Cl. CPC G06Q 40/06

(57) ABSTRACT

Limited data availability poses a major obstacle in training deep learning models for financial applications. Synthesizing financial time series (FTS) to augment real-world data is challenging due to irregular and scale-invariant patterns associated with FTS—temporal dynamics that repeat with varying duration and magnitude. A novel generative framework called FTS-Diffusion is developed, consisting of three modules to model irregular and scale-invariant patterns. First, a scale-invariant pattern recognition algorithm extracts recurring patterns that vary in duration and magnitude. Second, a pattern-conditioned diffusion network synthesizes segments of patterns. Third, the temporal evolution of patterns is modeled in order to aggregate the generated segments. Extensive experiments show that FTS-Diffusion generates synthetic FTS highly resembling observed data, outperforming state-of-the-art alternatives. Two downstream experiments demonstrate that augmenting real-world data with synthetic data generated by FTS-Diffusion reduces the error of stock market prediction by up to 17.9%.

ABBREVIATIONS

| | |
|---|---|
| AD | Anderson-Darling |
| AE | autoencoder |
| CSDI | conditional score-based diffusion model for imputation |
| DDPM | denoising diffusion probabilistic model |
| DTW | dynamic time warping |
| ECG | electrocardiogram |
| ELBO | evidence lower bound |
| FTS | financial time series |
| GAN | generative adversarial network |
| KS | Kolmogorov-Smirnov |
| LSTM | long short-term memory |
| MAPE | mean absolute percentage error |
| ML | machine learning |
| QQ | quantile-quantile |
| S&P | Standard & Poor's |
| SISC | scale-invariant subsequence clustering |
| TATR | training on augmentation, test on real |
| TCN | temporal convolutional |
| TMTR | training on mixture, test on real |

### TECHNICAL FIELD

The present disclosure relates to a ML technique for generating a synthetic FTS.

### BACKGROUND

In the field of financial economics, potential of deep learning to solve complex problems in financial settings has been widely demonstrated (Qin et al., 2017; Xu & Cohen, 2018; Wu et al., 2020; Manzo & Qiao, 2020; Huang & Li, 2021). However, a dearth of data and the low signal-to-noise ratio nature of financial data pose major obstacles that hinder the further development of deep learning in finance. Unlike other fields of science, finance researchers cannot run experiments to obtain more data, so FTS are limited by their existing history. Additionally, price and return data are subject to high levels of noise, making it even more challenging to extract useful information from a limited dataset. Deep learning models trained on insufficient data are prone to overfitting and cannot be expected to perform reliably on unseen data.

To alleviate data scarcity, data augmentation techniques can be employed. Generative models that capture the properties of the underlying data-generating process would produce synthetic data that resemble observed data. Recently, deep generative modeling, especially GANs (Goodfellow et al., 2014) and diffusion models (Ho et al., 2020), has made remarkable progress in multiple domains including image synthesis, reinforcement learning, and anomaly detection. They have also been applied to time series settings such as medical records, audio synthesis, power systems, and networked systems. Despite these advances, modeling FTS poses unique challenges that complicate the task and render existing models ineffective.

Time series studied in the extant literature of deep generative learning tend to exhibit some regularity. However, FTS are generally irregular. Generating a time series that matches characteristics of typical FTS is challenging.

A review of existing works related to ML-based generation of time series is first given. Advances in deep generative modeling have shown promise to generate time series data in various problem domains, particularly using VAEs-, GANs-, and diffusion-based models. The most relevant works are discussed as follows.

TimeVAE (Desai et al., 2021) is a VAE-based framework for modeling the trend and seasonality in time series. RCGAN (Esteban et al., 2017) and MV-GAN (Brophy, 2020) are GANs for learning medical records. Several GAN variants have been employed to model time series in power systems (Zhang et al., 2018; Chen et al., 2018). TimeGAN (Yoon et al., 2019) is a general framework for embedding time-series data into a latent space with an autoencoder network and subsequently learning the latent representation with GANs. QuantGAN (Wiese et al., 2020) is a GAN-based network for capturing long-range dependencies in FTS under the volatility-innovation decomposition. CSDI (Tashiro et al., 2021) is a score-based diffusion model primarily designed for imputation, with an unconditional variant that can be also used for time series generation. DiffWave (Kong et al., 2021) and BinauralGrad (Leng et al., 2022) are usable to generate waveform time series with diffusion models.

The above-mentioned approaches can model time series with regular patterns but struggle with more complex series characterized by irregularity and scale-invariance, which are central features in FTS. The identification of latent patterns in FTS is challenging, and it is difficult for a generative model without auxiliary information to distinguish between these diverse distributions.

There is a need in the art for an improved ML-based technique for generating FTS.

### SUMMARY

A first aspect of the present disclosure is to provide a first computer-implemented method for synthesizing a synthetic FTS.

In the first method, a reference FTS is first obtained. From the reference FTS, a set of scale-invariant patterns for modeling the synthetic FTS is learnt by performing a joint process of segmenting the reference FTS into a first sequence of reference-FTS segments with variable segment lengths and clustering a plurality of normalized segments derived from the first sequence into a plurality of clusters to yield a plurality of cluster centroids. Particularly, the joint process is performed under a segmentation requirement that a segment length of an individual reference-FTS segment is selected to minimize a distance from a normalized segment corresponding to the individual reference-FTS segment to a nearest centroid in the plurality of cluster centroids. In the joint process, the plurality of normalized segments is obtained via normalizing the individual reference-FTS segment in magnitude and in segment duration. After the plurality of cluster centroids is obtained, the plurality of cluster centroids is used as the plurality of scale-invariant patterns. The synthetic FTS is generated as a second sequence of synthetic-FTS segments with variable segment lengths. An individual synthetic-FTS segment is generated as a sample of a conditional distribution conditioned on a tuple of parameters associated with the individual synthetic-FTS segment. The tuple of parameters consists of a scale-invariant pattern selected from the set of scale-invariant patterns for controlling a waveshape of the generated individual synthetic-FTS segment, a magnitude-scaling factor for amplitude-scaling the waveshape in generating the individual synthetic-FTS segment, and a duration-scaling factor for controlling compression and expansion of the waveshape in time in generating the individual synthetic-FTS segment.

In certain embodiments, a greedy algorithm is employed in the joint process to jointly determine corresponding segment lengths of respective reference-FTS segments in the first sequence, and the plurality of cluster centroids.

In certain embodiments, the greedy algorithm comprises the steps of: (a) initializing the plurality of cluster centroids; (b) repeating a first subprocess until the reference FTS is fully segmented to form a candidate sequence of reference-FTS segments, wherein the first subprocess is programmed to determine a segment length of a presently-considered reference-FTS segment to fulfill the segmentation requirement given that respective sequence lengths of previously-considered reference-FTS segments have been determined; (c) after the step (b) is completed, updating the plurality of cluster centroids according to the candidate sequence of reference-FTS segments; (d) repeating a second subprocess with the updated plurality of cluster centroids until the candidate sequence of reference-FTS segments as a whole converges or until the second subprocess has been executed for a predetermined number of times, wherein the second subprocess comprises the steps (b) and (c); and (e) setting the candidate sequence of reference-FTS segments as obtained at completion of the step (d) to be the first sequence of reference-FTS segments.

In certain embodiments, the step (a) comprises performing the following tasks. First, a set of available reference-FTS segments is initialized. Respective segments in the initialized set of available reference-FTS segments are disjoint segments of the reference FTS and are of equal length. A set of cluster centroids is also initialized to be an empty set. When the set of cluster centroids is empty, the following three tasks are performed. First, a segment in the set of available reference-FTS segments is randomly selected to serve as a first cluster centroid in the set of cluster centroids. Second, the set of cluster centroids is updated with the first cluster centroid. Third, the set of available reference-FTS segments is updated by removing the selected segment that serves the first cluster centroid. Afterwards, a third subprocess with the updated set of cluster centroids and the updated set of available reference-FTS segments is repeated until the set of cluster centroids is filled with a preselected number of cluster centroids. The third subprocess comprises: selecting a segment in the set of available reference-FTS segments to serve as a new cluster centroid in the set of cluster centroids, wherein a weight of an individual segment in the set of available reference-FTS segments to be selected as the new cluster centroid is proportional to a distance from said individual segment to a closest centroid in the set of cluster centroids, and wherein the segment to serve the new cluster centroid is selected according to respective weights computed for the set of available reference-FTS segments; updating the set of cluster centroids with the new cluster centroid; and updating the set of available reference-FTS segments by removing the selected segment that serves the new cluster centroid. After the set of cluster centroids is filled with the preselected number of cluster centroids, the set of cluster centroids is set as the initialized plurality of cluster centroids.

In certain embodiments, DTW is used as a distance matric in computing the distance from the normalized segment corresponding to the individual reference-FTS segment to the nearest centroid in the plurality of cluster centroids.

In certain embodiments, the conditional distribution is a multivariate Gaussian distribution.

In certain embodiments, the first method further comprises performing the following tasks. Before the synthetic FTS is generated, first and second ML models are set up. The first ML model is used for generating a second tuple of parameters from a first tuple of parameters. The second tuple of parameters is used for modeling a second synthetic-FTS segment in the second sequence. The first tuple of parameters is used for modeling a first synthetic-FTS segment that immediately precedes the second synthetic-FTS segment in the second sequence. As a result, temporal dynamics of the synthetic FTS are learnt. The first ML model is trained with the reference FTS. The second ML model is used for generating the individual synthetic-FTS segment in the second sequence according to an input tuple of parameters. The second ML model is trained with the first sequence. Additionally, the generating of the synthetic FTS as the second sequence of synthetic-FTS segments with variable segment lengths comprises recursively using the first and second ML models to generate consecutive synthetic-FTS segments for the second sequence.

In certain embodiments, an initial segment among the consecutive synthetic-FTS segment is generated by the second ML model with an initial tuple of parameters used as the input tuple of parameters. The initial tuple of parameters may be generated from the first ML model. Alternatively, the initial tuple of parameters may be externally received from outside the first and second ML models.

In certain embodiments, the second ML model comprises a scaling AE and a pattern-conditioned diffusion network. The scaling AE comprises an encoder for transforming a first variable-length segment into a first fixed-length segment, and a decoder for transforming a second fixed-length segment from a second variable-length segment. The first variable-length segment is computed according to the input tuple of parameters. The second variable-length segment is used as one synthetic-FTS segment in the second sequence. The scaling AE is trained according to the reference FTS and the set of scale-invariant patterns. The pattern-conditioned diffusion network is used for generating the second fixed-length segment from the first fixed-length segment.

In certain embodiments, the pattern-conditioned diffusion network is realized according to a DDPM.

A second aspect of the present disclosure is to provide a second computer-implemented method for testing a financial computing system.

In the second method, plural synthetic FTS are generated by the first method. The financial computing system is then tested under testing conditions respectively defined by the plural synthetic FTS. In a first option, the plural synthetic FTS are generated by the first method with plural reference FTS that are mutually-different, respectively. In a second option, the plural synthetic FTS are generated by the first method under one reference FTS with plural initial tuples of parameters that are mutually-different, respectively.

A third aspect of the present disclosure is to provide a third computer-implemented method for predicting a stock price.

In the third method, a historical FTS is obtained. The historical FTS is a time series recording historical values of the stock price over a certain duration of time. Future values of the stock price are then predicted by a synthetic FTS synthesized by the first method with the historical FTS being used as the reference FTS. In executing the first method, the initial tuple of parameters is generated as a corresponding second tuple of parameters by the first ML model with a corresponding first tuple of parameters. The corresponding first tuple of parameters is a tuple of parameters associated with a last reference-FTS segment in the first sequence such that the synthetic FTS is a predicted continuation of the reference FTS.

A fourth aspect of the present disclosure is to provide a fourth computer-implemented method for automatically trading a stock.

In the fourth method, future values of a stock price of the stock are predicted by the third method. A trading decision on the stock is automatically made according to the future values of the stock price.

Other aspects of the present disclosure are disclosed as illustrated by the embodiments hereinafter.

### BRIEF DESCRIPTION OF THE DRAWINGS

FIG. 1 plots time-series data of various data sources in subplots (a)-(d) as examples for illustrating irregular and scale-invariant patterns in FTS, where: subplot (a) plots data of S&P 500 price (finance); subplot (b) plots ECG data (medical); subplot (c) plots data obtained in solar generation (renewable energy); and subplot (d) plots power consumption data (smart grid).

FIG. 2 depicts a schematic diagram of an exemplary realization of a FTS-Diffusion framework as disclosed herein, showing that the framework is composed of a pattern recognition module, a pattern generation module, and a pattern evolution module.

FIG. 3 depicts key design aspects of the three modules in the FTS-Diffusion framework.

FIG. 4 provides experimental results for comparison of stylized facts of real and generated S&P 500 over 10 years, where the generated S&P 500 was obtained by using the FTS-Diffusion framework.

FIG. 5 provides various plots regarding prediction errors of the downstream model trained under the TMTR and TATR settings, showing that the FTS-diffusion framework maintains a comparable level of prediction accuracy across all mixing proportions of synthetic data and reduces the prediction errors by augmenting the observed dataset.

FIG. 6 depicts a first workflow showing exemplary steps of a first computer-implemented method for synthesizing a synthetic FTS as disclosed herein.

FIG. 7 depicts a second workflow showing exemplary steps of a SISC algorithm as used in the first disclosed method.

FIG. 8 depicts exemplary steps executed by an initialization step of the first disclosed method.

FIG. 9 depicts a third workflow showing exemplary steps of a second computer-implemented method for testing a financial computing system, where the second method utilizes the first method to synthesize a plurality of synthetic FTS.

FIG. 10 depicts a fourth workflow showing exemplary steps of a third computer-implemented method for predicting a stock price, where the third method utilizes the first method to synthesize a synthetic FTS to reflect future values of the stock price.

FIG. 11 depicts a fifth workflow showing exemplary steps of a fourth computer-implemented method for automatically trading a stock, where the third method is utilized to first predict future values of a stock price of the stock.

Skilled artisans will appreciate that elements in the figures are illustrated for simplicity and clarity and have not necessarily been depicted to scale.

### DETAILED DESCRIPTION

Disclosed herein is a ML technique for synthesizing a synthetic FTS. The technique addresses irregularity and scale invariance of typical FTS in generating the synthetic FTS. The ML technique is herein referred to as FTS-Diffusion. After the FTS-Diffusion framework is detailed, embodiments of the present disclosure will be elaborated based on disclosed details, examples, applications, etc. of the framework.

### 1. Overview of Disclosed FTS-Diffusion

In accordance with the present disclosure, the FTS generation by FTS-Diffusion is decomposed into a pattern recognition-generation-evolution process. This decomposition enables better modeling of the irregular and scale-invariant properties. In addition, diffusion probabilistic models have been shown to achieve better quality and training stability than the classical GAN and VAE models (Dhariwal & Nichol, 2021; Wang et al., 2021). Hence, a generative model leveraging the DDPM is designed in the present disclosure. For details of DDPMs, see Ho et al. (2020).

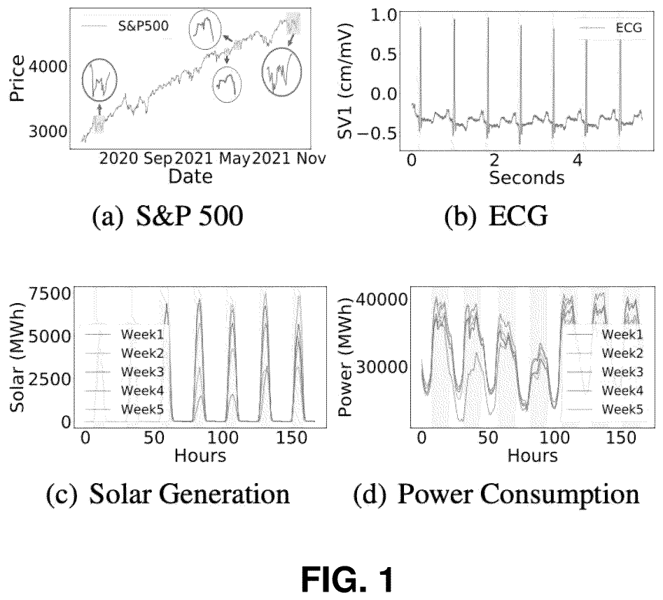

To begin with, it is noted that the time series studied in the extant literature of deep generative learning tend to exhibit some regularity. Patterns identified in these data appear at fixed or predictable increments in calendar time (e.g., heartbeats in ECG). Time series data that contain such regular patterns are amenable to modeling, as they allow extraction of highly correlated features from similar repeating patterns. Although conceptually straightforward, identifying recurring patterns in FTS proves to be difficult due to a lack of regularity. Instead, FTS appear to contain more subtle patterns that repeat themselves with varying duration and magnitude, a quality that is referred to as scale-invariance. Irregularity and scale-invariance are hallmarks of FTS that complicate their modeling and the synthesis of additional data. These two properties are illustrated in FIG. 1.

FIG. 1 plots time-series data of (a) S&P 500 price (finance), (b) ECG (medical), (c) solar generation (renewable energy), and (d) power consumption (smart grid). By comparing the S&P 500 Index, which represents a broad basket of U.S. stocks, to several regular series, it is observed that the three regular series exhibit clear and consistent patterns that align with calendar time. In contrast, neat patterns that adhere to a fixed frequency for the S&P 500 are not observed. Instead, one can observe similar patterns (highlighted in circles) that exhibit scale-invariance in subplot (a) of FIG. 1. These patterns keep their basic shape but are shifted or stretched compared to each other. In short, a FTS expresses complex patterns that are irregular and scale-invariant. The unique properties of FTS make data synthesis a significantly more challenging task compared to that of well-behaved data. Effective time series data generation considering irregularity and scale-invariance remains largely an open problem.

To address this problem, the Inventors deconstruct a FTS generation into a three-prong process: (i) pattern recognition to identify irregular and scale-invariant patterns; (ii) generation to synthesize segments of patterns; and (iii) evolution to connect the generated segments into a complete time series. The present disclosure provides a new generative framework, FTS-Diffusion, to accomplish the pattern recognition-generation-evolution process. It is found that FTS-Diffusion is capable of generating synthetic FTS that closely resemble observed data.

In the present disclosure, the unique architecture of FTS-Diffusion is designed to handle irregularity and scale-invariance. There are three modules. The pattern recognition module is based on a new SISC algorithm (Section 3.1). By incorporating DTW, SISC is able to accurately identify and separate irregular and scale-invariance patterns. The generation module includes a diffusion-based network to synthesize scale-invariant segments conditioned on patterns learned by the SISC algorithm (Section 3.2). The evolution module is made up of a pattern transition network that produces the temporal evolution of consecutive patterns, capturing the dynamic relationship among the patterns (Section 3.3).

In the present disclosure, the effectiveness of FTS-Diffusion in capturing real-world financial data is demonstrated and the value of the generated data for downstream applications is illustrated (Section 4). Patterns identified by FTS-Diffusion can be cross-verified with financial domain knowledge of, e.g., Lo et al. (2000). Experimental results from three real-world datasets show that FTS-Diffusion generate the most realistic FTS among several alternative models. The usage of the generated data for the downstream task of predicting stock prices is explored in the present disclosure. Augmenting limited real-world data with synthetic samples from FTS-Diffusion reduces the predictive error by up to 17.9% across the datasets. These results shed light on the capability of FTS-Diffusion to improve the accuracy and reliability of deep learning models in financial applications.

### 2. Problem Statement

### 2.1. Unique Characteristics of FTS

The irregular and scale-invariant patterns in FTS are difficult for existing models that assume regularity and uniformity to capture. The typical technique of dividing time series into fixed-interval segments in existing approaches is likely to result in a snapshot of either a fraction of a pattern or a mixture of multiple patterns.

A novel framework for modeling irregular and scale-invariant time series is disclosed. A time series X={x₁, . . . , x_{M}}consists of M segments, xₘ={X_{m,1}, . . . , x_{m,t}_{ₘ}}. The length of the entire time series is

$$T = {\sum }_{m = 1}^{M} {t}_{m} .$$

The mth segment, xₘ, is sampled from a conditional distribution f(⋅|p,α,β) dependent on the pattern p∈ [symbol] whose duration is scaled by a and magnitude scaled by β. By this way, xₘ is statistically similar to its underlying pattern p while allowing for adjustments in duration and magnitude. To model the dynamics across patterns, we employ a Markov chain. Each tuple (p,α,β) is a state, and the state transition probabilities Q(pⱼ,αⱼ,βⱼ|pᵢ,αᵢ,βᵢ) describe the stochastic transition from one pattern to the next. Our setup is reminiscent of applications of the Markov property in FTS (Dueker, 1997; Bai & Wang, 2011; Somani et al., 2014). The novelty in the presently adopted approach is that a Markov model is used to capture the transition of three specific aspects of the time series, namely, pattern, duration, and magnitude, whereas existing works attempt to recover some unspecified latent properties of a time series.

### 2.2. Problem Statement Details

It is required to operationalize the structure laid out in Section 2.1. When faced with a time series, we have no knowledge of the segments

$${\{ {x}_{m} \}}_{m = 1}^{M} ,$$

the set of scale-invariant patterns [symbol] , or the scaling factors α and β that transform a reference pattern into its more realistic counterpart. We also do not know the transition probabilities Q(pⱼ,αⱼ,βⱼ|pᵢ,αᵢ,βᵢ). Our goal is to develop a data-driven framework to accomplish the following tasks:
Pattern Recognition—to identify the patterns and learn the recurrent structures [symbol] , and group segments into clusters according to their corresponding patterns p∈ [symbol] ;
Pattern Generation—to learn the distribution f(⋅|p,α,β), ∀p∈ [symbol] ; and
Pattern Evolution—to learn the pattern transition probabilities Q(pⱼ,αⱼ,βⱼ|pᵢ,αᵢ,βᵢ).

The three components as listed above allow us to generate a FTS by (i) determining the allocation of patterns using the pattern transition probabilities, and (ii) generating each segment from the corresponding pattern with the appropriate duration and magnitude scaling factors. Our three-pronged framework dedicated to identifying and modeling the irregular and scale-invariant patterns observed in FTS is the first of its kind in the literature.

### 3. FTS-Diffusion Framework

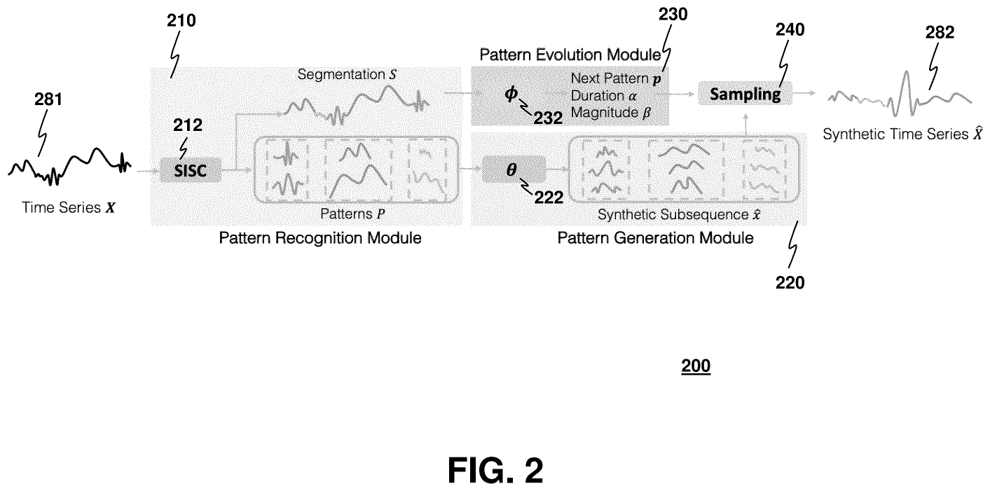

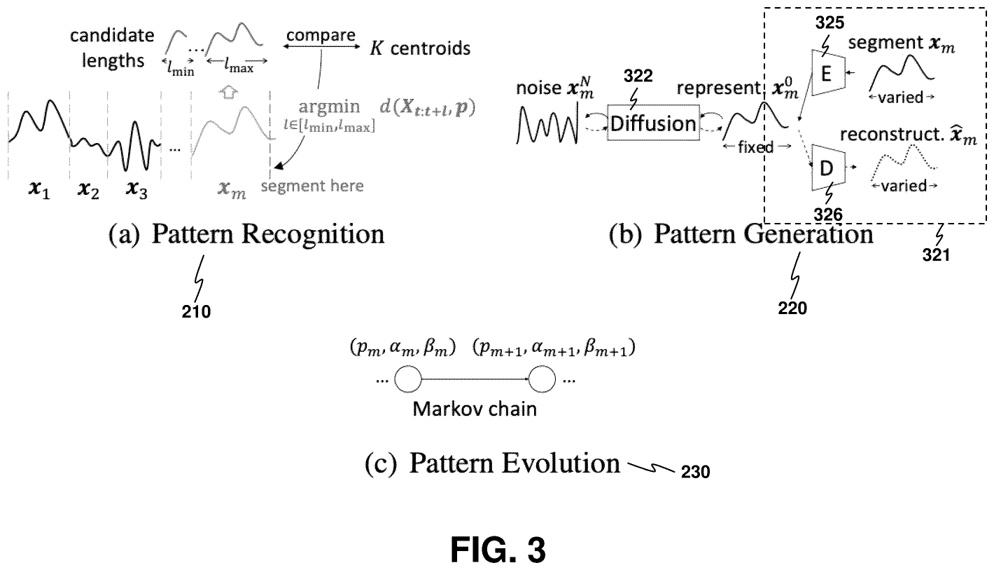

The data-driven framework developed for accomplishing the tasks of pattern recognition, pattern generation and pattern evolution is the FTS-Diffusion network. In this section, the disclosed FTS-Diffusion framework is detailed with the aid of FIGS. 2 and 3. Before the FTS-Diffusion framework is detailed, a summary of FIGS. 2 and 3 is given as follows.

FIG. 2 depicts a schematic diagram of an exemplary FTS-Diffusion framework 200. The FTS-Diffusion framework 200 includes three components: a pattern recognition module 210, a pattern generation module 220, and a pattern evolution module 230. The pattern recognition module 210 identifies scale-invariant patterns within an entire FTS 281 under consideration by using a SISC algorithm 212 as proposed herein. Subsequently, the pattern generation module 220 synthesizes resultant segments with a diffusion-based network conditioned on the patterns. Finally, the pattern evolution module 230 connects the generated segments to construct a synthetic FTS 282 following the transition between consecutive patterns. FIG. 3 depicts key design aspects in each of the modules 210, 220, 230. In the pattern recognition module 210, the key design is the SISC algorithm 212, which is a greedy segmentation algorithm. In the pattern generation module 220, the key design is a pattern-conditioned diffusion network 322 paired with a scaling AE 321. In the pattern evolution module 230, a Markov transition estimator is the key design.

### 3.1. Pattern Recognition: Identifying Irregular and Scale-Invariant Patterns

A novel algorithm, the SISC algorithm 212, is proposed to partition the entire FTS 281 into segments of variable lengths and group these variable-length segments into K distinct clusters. The segments within the same cluster exhibit similar shapes after proper scaling in duration and magnitude. The centroid of each cluster then represents a scale-invariant pattern in the FTS under consideration 281.

The idea is similar to the traditional K-Means clustering (Hartigan & Wong, 1979), which primarily clusters segments of identical length and thus falls short in our context due to its inability to handle segments of varying lengths and magnitudes. Instead of separating the entire time series into equal-length segments as is commonly done, we adaptively determine the optimal segment lengths through a simple yet effective greedy segmentation strategy. Specifically, as illustrated in FIG. 3, subplot (a), we compare the segments of candidate lengths l∈[lₘᵢₙ,lₘₐₓ] with cluster centroids within a normalized space at each evaluated position

$$t = {\sum }_{τ = 0}^{m - 1} {t}_{τ} .$$

The length l* that minimizes the distance to the nearest centroid is considered the optimal segmentation for the current segment xₘ=X_{t:t+l*}, i.e.,

$${l}^{*} = {min}_{l ∈ [ {l}_{min} , {l}_{max} ]} d ( {X}_{t : t + l} , p ) , ∀ p ∈ 𝒫 \qquad ( 1 )$$

The first key component in our design is a distance metric d( [symbol] ) that is robust to varying lengths and magnitudes and hence properly measures the difference between subsequences. Classical metrics, such as Euclidean distance, fail to provide accurate measurements due to their limitations in comparing variable-length sequences. In contrast, we employ DTW to calculate the minimum distance across all pointwise alignments between two segments:

$$D TW ( x , y ) = {min}_{A ∈ A} 〈 A , Δ ( x , y ) 〉 , \qquad ( 2 )$$

where A denotes the alignment between two sequences in the set of all possible alignments [symbol] , and Δ(x,y)=[δ(xᵢ,yⱼ)]_{i,j} is the pointwise distance matrix between two normalized sequences x and y. It well-suits our purpose to identify similarities in segments with similar shapes but varying duration and magnitudes. With the DTW metric denoted as d( [symbol] ), we apply the greedy segmentation strategy from the start to the end of the time series. Upon completing the greedy segmentation across the entire time series, we proceed with the standard K-means clustering process. Each segment is assigned to its nearest centroid, then the centroids are updated based on new cluster assignments. This process iterates until cluster assignments stabilize or a pre-determined number of iterations is reached.

The second key component in our design is the initialization of the cluster centroids. The random initialization typically used in standard clustering methods often yields suboptimal results. To alleviate this issue, we design an intelligent initialization scheme for more informed initial centroids. Our initialization begins by randomly selecting one segment from all available segments of a pre-specified length, which could be either the minimum or maximum length in practice, to serve as the first centroid. Afterward, we choose the subsequent centroids from the rest, with the selection weight being proportional to their distances to the closest centroid within the chosen set. It means that segments located farther from their nearest centroid have a higher probability of being the next choice. We repeat this process until K centroids are initialized. The aforementioned approach ensures a diverse set of centroids spreading across the data space, promoting an efficient start of the SISC algorithm 212.

We highlight that the disclosed SISC algorithm 212 is advantageously designed to identify scale-invariant patterns. The computational complexity of the SISC algorithm 212 is O(TKIₘₐₓ), which is linear to the length of the entire time series. The pseudo-code of the SISC algorithm 212 and the selection of parameters, such as the range of segment lengths and the number of clusters K, are detailed as follows.

### 3.1.1. Details of SISC Algorithm

The pseudo-code of the SISC algorithm 212 is presented as Algorithm 1. As introduced in Section 3.1, SISC is performed with two main stages: (i) initializing the cluster centroids (Cluster Initialization in Algorithm 1); and (ii) segmenting and clustering the subsequences into K clusters using a greedy strategy (Greedy Segmentation and Clustering in Algorithm 1).

Algorithm 1: SISC Algorithm.

```
Require: Time series X; pre-determined number of clusters K; minimum and maximum
subsequence length lₘᵢₙ and lₘₐₓ; maximum iterations max iters
  1. P ← ϕ
  $2. Prepare candidate centroids {\{ {X}_{t : t + {l}_{max}} \}}_{t = 0}^{T - {l}_{max}}$
  3. Randomly select the first centroid p₀ from the candidates
  4. P.append(p₀)
  5. while P.size < K do <Remark: Cluster Initialization>
  6. Compute the distance to the nearest chosen centroid for each remaining
      candidate
  7. Set the probability of each candidate proportional to the above distance
  8. Randomly select the next centroid pₖ with the above probability
  9. P.append(pₖ)
10. end while
11. iter ← 0
12. while iter < max_iters do <Remark: Greedy Segmentation and Clustering>
13. S ← 0
14. t ← 0
15. while t ← T do
16. l* ← argmin_{l∈[l}_{ₘᵢₙ}_{,l}_{ₘₐₓ}_{]}DTW(X_{t:t+1}, p), ∀p ∈ P
17. S.append(l*)
18. t ← t + l*
19. end while
20. iter ← iter + 1
21. Update P
22. end while
23. Return P, S
```

In numerical experiments in Section 4, leveraging domain knowledge in finance, we set the minimum and maximum segment lengths as 10 and 21, respectively, focusing on the atom-like short-term patterns commonly observed (Lo et al., 2000). Applying the elbow method (Thorndike, 1953), we empirically determine the values of K for three financial assets, which are 14, 11, and 11, respectively.

### 3.2. Pattern Generation: Learning Pattern-Conditioned Temporal Dynamics

The pattern generation module 220, utilizing a ML model denoted as θ222 as shown in FIG. 2, is developed to synthesize the segments of patterns. The goal is to generate new segments that mimic the temporal dynamics within the observed segments. Considering a FTS as a collection of scale-invariant patterns, one can interpret the data-generating process as capturing the distribution of reference patterns and transforming these reference patterns with proper scales in duration and magnitude. Accordingly, we instantiate this data-generating process by using two dedicated networks for the two tasks, as discussed as follows. The two dedicated networks collectively form the ML model θ222.

The first network is a scaling AE 321 for learning the transformation between variable-length segments x and respective fixed-length representations x⁰, after we capture the reference pattern representation using a pattern-conditioned diffusion network 322. The scaling AE 321 has an encoder 325 (for performing an encoding function) and a decoder 326 (for performing a decoding function). The encoder 325 stretches the variable-length segments into fixed-length representations that align with the dimension of reference patterns. The decoder 326, on the other hand, is responsible for reconstructing the variable-length segments from the fixed-length representations.

The second network is the pattern-conditioned diffusion network 322 for simulating a diffusion-denoising process—perturbing the pattern representations gradually by adding noise over N steps (diffusion) and removing the noise to gradually recover the original representation (denoising). The diffusion process is achieved by a pre-specified procedure of incrementally adding Gaussian noise step by step, while the denoising process is approximated by a neural network that learns the removing noise at each step, i.e. the denoising gradient. Approximating the stepwise denoising gradients is equivalent to learning the mapping from a latent Gaussian space to the pattern space. Consequently, given a Gaussian noise, we can generate a pattern representation. The continuous nature of the Gaussian space implies that we can sample an infinite amount of Gaussian noise and produce corresponding new pattern representations. We build the diffusion network 322 based on the DDPM (Ho et al., 2020). In detail, we apply the following diffusion process at each step i to corrupt the representation into noise:

$$q ( {x}_{i} \vert {x}_{i - 1} ) = ( {x}_{i} ; \sqrt{1 - β} ( {x}_{i - 1} - p ) , β I ) \qquad ( 3 )$$

where β represents the magnitude of the segments. Thereafter, we design a conditional denoising process that recovers the target segments from a prior Gaussian noise conditioned on the reference patterns over the reversed N steps:

$${p}_{θ} ( {x}_{i - 1} \vert {x}_{i} ) = ( {x}_{i - 1} ; {μ}_{θ} ( {x}_{i} , i , p ) , β I ) \qquad ( 4 )$$

where μ_{θ} is proportional to ϵ_{θ} representing the neural network that learns the denoising gradient at each step. Note that the superscript i denotes the step in the diffusion and denoising process.

Some implementation details of the pattern-conditioned diffusion network 322 and scaling AE 321 are given as follows. The pattern-conditioned diffusion network 322 utilizes six residual TCN blocks to capture internal temporal dynamics within pattern segments. Each block mainly comprises two temporal convolution layers. Time embeddings for each diffusion step are constructed with a fully-connected layer positioned at the top of each block. We set the number of diffusion steps to N=100. The scaling AE 321 can be implemented with two layers of LSTMs or GRUs.

We jointly train the pattern-conditioned diffusion network 322 and the scaling AE 321 by using the standard supervised learning with the segments identified in Section 3.1 as training data. In particular, we jointly train these two networks 321, 322 by following this procedure using the Adam optimizer with a learning rate of 5×10′. We set the batch size to 32. The hyper-parameters are determined empirically by using common techniques in the literature.

As depicted in subplot (b) of FIG. 3, the observed segments are encoded and perturbed to noise by the encoder 325 in the scaling AE 321 and the diffusion process in the pattern-conditioned diffusion network 322. The generation process, marked with dashed arrows, reverses this noise perturbation process by denoising and decoding the segments from noise through the denoising process in the diffusion network 323 and the decoder 326 in the scaling AE 321. During this process, it is required to ensure that (i) the diffusion and denoising gradients are consistent at each step, and (ii) the reconstruction successfully reproduces the observed segments. Therefore, the objective contains the reconstruction loss between the observed and reconstructed segments for the scaling AE 321 and the unweighted variant of the variational lower bound (or ELBO) (Ho et al., 2020) for the pattern-conditioned diffusion network 322:

$$ℒ ( θ ) = {𝔼}_{{x}_{m}} [ {‖ {x}_{m} - {\hat{x}}_{m} ‖}_{2}^{2} ] + {𝔼}_{{x}_{m}^{0} , i , ϵ} [ {‖ {ϵ}^{i} - {ϵ}_{θ} ( {x}_{m}^{i} , i , p ) ‖}_{2}^{2} ] \qquad ( 5 )$$

where ϵⁱ is the noise added in the corresponding diffusion process at step i.

During the generation phase, new segments can be created by exclusively applying the denoising process in the pattern-conditioned diffusion network 322 and the decoder 326 in the scaling AE 321.

### 3.3. Pattern Evolution: Learning the Transition Between Consecutive Patterns

As mentioned in Section 2.1, we model the transition states (encompassing patterns, lengths, and magnitudes) between consecutive generated segments using a Markov chain. Once the transition states are determined, we obtain an evolution series of patterns, somehow addressing the irregularity in FTS. It ensures that the consecutive generated segments maintain the essential temporal correlations observed in real-world financial data. To capture the Markov-chain modeled temporal dynamics across patterns, we introduce a pattern evolution network ϕ232 to learn the temporal evolution of the states between consecutive segments. As a remark, we do not estimate transitions using traditional Markov models, but our neural network-based approach avoids unwieldy transition matrices, generalizes well to unseen scenarios, and handles non-linear dependencies adeptly. More specifically, the pattern evolution network 232 learns the probability of the next pattern along with its corresponding length and magnitude, given the current state (because of the Markov property):

$$( {\hat{p}}_{m + 1} , {\hat{α}}_{m + 1} , {\hat{β}}_{m + 1} ) = ϕ ( {p}_{m} , {α}_{m} , {β}_{m} ) , \qquad ( 6 )$$

where (\hat{p}ₘ₊₁, \hat{α}ₘ₊₁, \hat{β}ₘ₊₁) denotes the next pattern and its scales in length and magnitude.

The pattern evolution network 232 is trained to optimize the following objective:

$$ℒ ( ϕ ) = {𝔼}_{{x}_{m}} [ {ℓ}_{CE} ( {p}_{m + 1} , {\hat{p}}_{m + 1} ) + {‖ {α}_{m + 1} , {\hat{α}}_{m + 1} ‖}_{2}^{2} + {‖ {β}_{m + 1} , {\hat{β}}_{m + 1} ‖}_{2}^{2} ] \qquad ( 7 )$$

where [symbol] _{CE}( [symbol] ) represents the cross-entropy.

Some implementation details of the pattern evolution network 232 are given as follows. In practice, we treat the modeling of the next pattern p as a multi-category classification, while the learning of the length-scaling factor α and the magnitude-scaling factor β as regression. Note that treating the estimation of the length as a classification task is also feasible. Hence, the pattern evolution network 232 models the Markov transition of state (p,α,β) between consecutive segments by a fully-connected neural network with three corresponding outputs. We train the pattern evolution network 232 by using the Adam optimizer with a learning rate of 40,000 over 1000 epochs. The hyper-parameters are determined empirically.

### 3.4. Putting Everything Together: Synthesizing Entire FTS

We regard patterns as the basic building blocks of generation. Accordingly, FTS-Diffusion produces a synthetic time series on a pattern-by-pattern basis.

Given an initial segment sampled from the historical data, the FTS-Diffusion framework 200 generates successive segments by employing the pattern generation module 220 and the pattern evolution module 230 iteratively, as outlined in Section 3.4.1 below. At each position m, the pattern evolution network ϕ232 predicts the next pattern pₘ₊₁, its length-scaling factor αₘ₊₁, and magnitude-scaling factor βₘ₊₁. With these states, the pattern generation module 220 generates the next segment xₘ₊₁. The synthetic time series then grows as more segments are generated and appended. This procedure is repeated until the entire time series reaches the desired total length.

### 3.4.1. Pseudo-Code of the Sampling Process

A pseudo-code of the sampling process carried out in the FTS-Diffusion framework 200 is provided as Algorithm 2. We commence the creation of a new synthetic time series by initializing the first segment, which is sampled from the observed data. After the initialization, subsequent segments are produced iteratively through the following procedure. In each iteration, the transition states of the next segment are first predicted using the pattern evolution module 230. With these states, the next segment is generated by the pattern generation module 220. This newly generated segment is then appended to the synthetic time series. This iterative process is repeated until the synthetic time series reaches the desired length.

Algorithm 2: Data synthesizing procedure incorporating the
pattern generation module and pattern evolution module.

Require: Pattern generation module θ, pattern evolution module Φ, latent patterns P,
terminal series length T

| | |
|---|---|
| 1. | \hat{X} ← Ø |
| 2. | Initialize x₀ ∈ X |
| 3. | \hat{X}.append(x₀) |
| 4. | m ← 0 |
| 5. | while len(X) < T do |
| 6. | pₘ, αₘ, βₘ ← TransitionStates(xₘ) |
| 7. | (pₘ₊₁, αₘ, βₘ) ← Φ(pₘ, αₘ, βₘ) |
| 8. | xₘ₊₁ ← θ(pₘ₊₁, αₘ, βₘ) |
| 9. | \hat{X}.append(xₘ₊₁) |
| 10. | m ← m + 1 |
| 11. | end while |
| 12. | Return \hat{X} |

### 4. Numerical Experiments

We conducted numerical experiments to evaluate the performance of the FTS-Diffusion framework 200 compared with alternatives, i.e. whether the generated data resemble real data and would be useful for downstream tasks.

### 4.1. Data and Experimental Setting

We ran experiments on three different types of financial assets with varying characteristics: the Standard and Poor's 500 index (S&P 500), the stock price of Google (GOOG), and the corn futures traded on the Chicago Board of Trade (ZC=F). In finance, it is known that raw asset prices follow a non-stationary random walk and are not well-behaved for statistical models. Instead, the returns, i.e. closing price changes in consecutive time intervals, remain with relatively constant statistical properties (such as mean and variance) over time. Thus, we compared the return series generated by FTS-Diffusion to those by representative baselines: RCGAN (Esteban et al., 2017), TimeGAN (Yoon et al., 2019), and CSDI (Tashiro et al., 2021).

TABLE 1
Generated return distributions compared to observed data. The KS and
AD statistics are floored/capped at 0/1 and 0.01/0.25, respectively.
A higher value indicates better goodness of fit. Variation in the test
statistic across multiple runs is shown with a +/− range.

| | S&P500 | | GOOG | | ZC═F | |
|---|---|---|---|---|---|---|
| Model | KS | AD | KS | AD | KS | AD |
| RCGAN | .189 ± .006 | .073 ± .004 | .185 ± .006 | .068 ± .004 | .179 ± .006 | .065 ± .005 |
| TimeGAN | .293 ± .004 | .115 ± .006 | .288 ± .007 | .108 ± .005 | .287 ± .007 | .103 ± .005 |
| CSDI | .168 ± .003 | .069 ± .002 | .156 ± .004 | .067 ± .003 | .157 ± .003 | .065 ± .003 |
| (Generative) | | | | | | |
| FTS- | .327 ± .003 | .128 ± .003 | .324 ± .004 | .119 ± .002 | .325 ± .003 | .121 ± .003 |
| Diffusion | | | | | | |

### 4.2. Properties of Synthetic Time Series

The synthetic FTS should inherit the stylized facts (Cont, 2001; Barberis & Shleifer, 2003) of asset returns, and resemble the distribution of observed data to a high degree of fidelity.

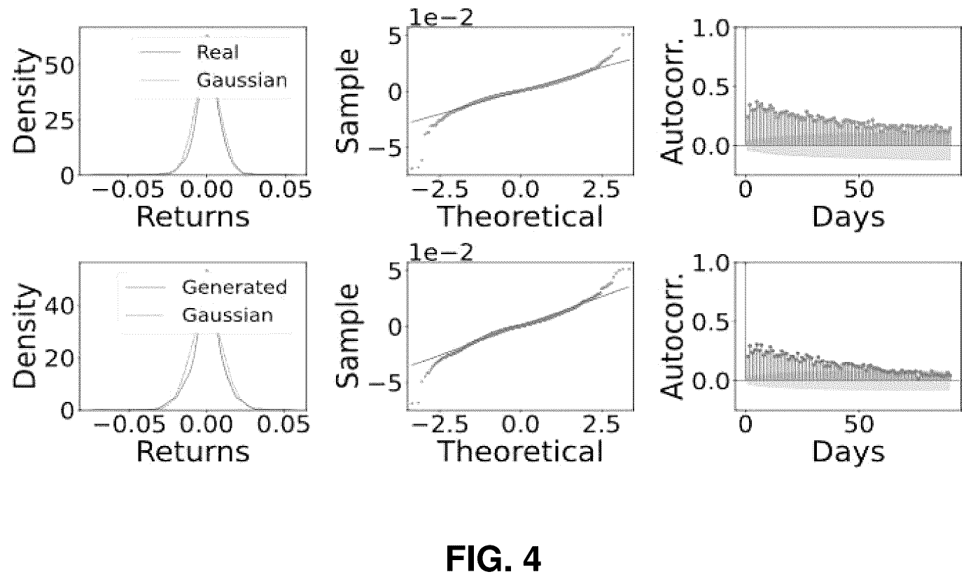

Stylized facts of FTS. The empirical properties of FTS have been studied extensively in the literature, which is often referred to as stylized facts (Cont, 2001; Barberis & Shleifer, 2003). The empirical studies reveal that asset returns have heavy tails, and the autocorrelation of absolute returns decays slowly over time. We assessed whether the synthetic time series adhere to these stylized facts based on obtained results shown on FIG. 4. FIG. 4 provides various plots for comparing stylized facts of real and generated S&P 500 over 10 years. Specifically, results on the heavy-tailed distribution (fat tails compared to the Gaussian in density and QQ-plot) are reported in the first two columns of FIG. 4, and results on decaying auto-correlations in absolute return are reported in the last column thereof. From the results, it reveals that the synthetic series exhibit significant heavy tails in their distribution and gradual decay in the autocorrelation of absolute returns, conforming to the aforementioned stylized facts. These results suggest that our approach is capable of generating synthetic FTS that preserve the essential properties of observed data.

Distribution comparison. We also evaluated the discrepancy between the distribution of the synthetic time series and that of observed data, using the KS test and the AD test as evaluation metrics. These tests estimate the goodness of fit between the synthesized distribution and the distribution of actual returns. For both tests, a larger test statistic indicates a higher degree of similarity between the distributions. The KS test is more sensitive to differences in the center of the distribution, whereas the AD test is more aware of the tails of the distribution. Table 1 demonstrates that our FTS-Diffusion learns a quantitatively closer distribution to the observed data, compared to other baselines. This result further confirms the efficacy of our approach in generating FTS that resemble the observed data.

### 4.3. Downstream Prediction Analysis of Synthetic FTS

We expanded “Training on Synthetic, Test on Real” (Esteban et al., 2017; Jordon et al., 2018) and designed two new settings to evaluate usefulness of the synthetic data for downstream tasks. Specifically, we focused on the task of prediction and implemented a LSTM-based downstream predictive model. This structure is a prevalent choice in the literature (Yoon et al., 2019; Jeon et al., 2022; Remlinger et al., 2022). The downstream model was employed to predict the next data point in the series, using the 64 previous historical values as input. We computed the MAPE averaged over multiple runs.

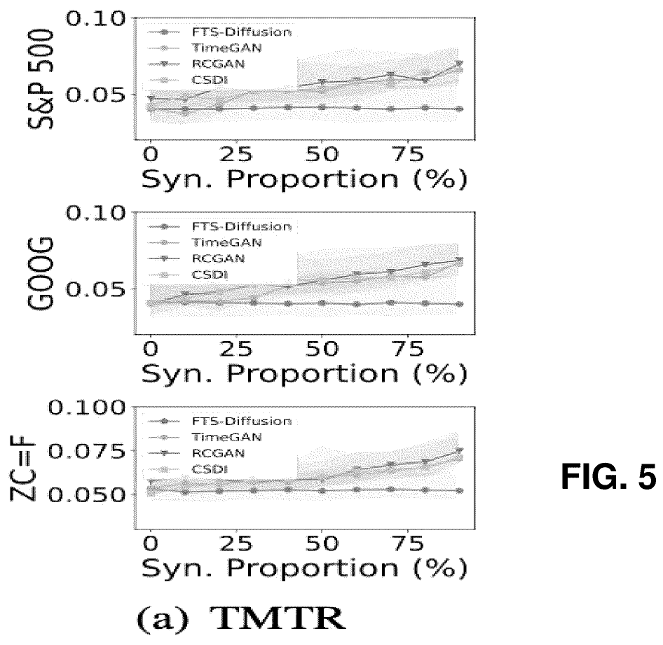

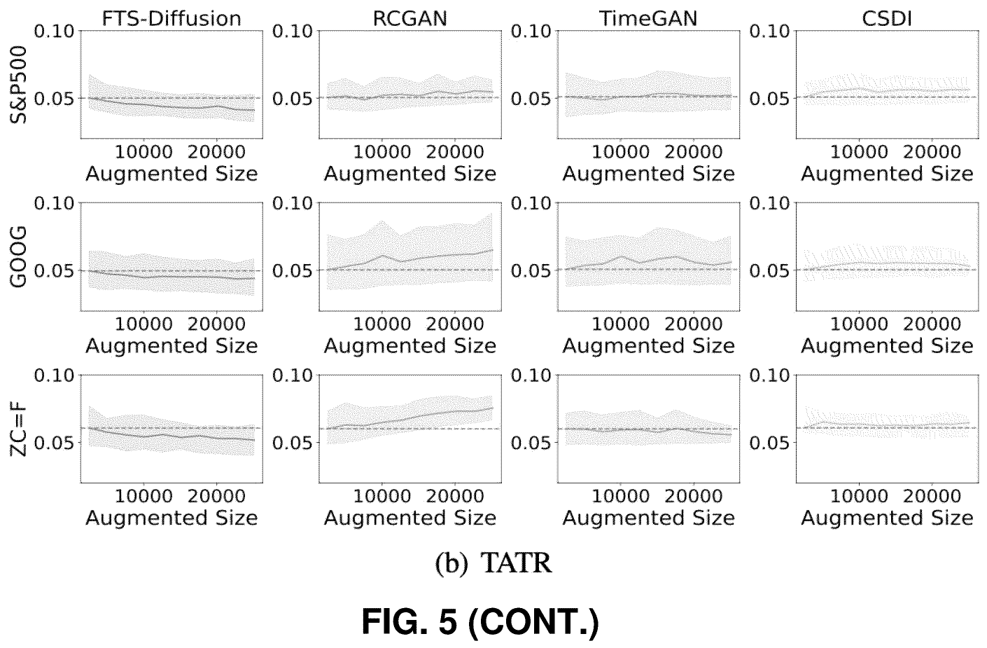

FIG. 5 provides various plots regarding prediction errors of the downstream model trained under the TMTR and TATR settings. Solid lines and shaded bands in each subplot represents the average error and the 95% confidence interval over multiple runs, respectively. Dashed lines in each TATR test mark the initial prediction errors. In summary, the FTS-diffusion framework 200 maintains a comparable level of prediction accuracy across all mixing proportions of synthetic data and reduces the prediction errors by augmenting the observed dataset.

Separate discussion on results regarding TMTR and TATR follows.

TMTR. In this setting, we trained the downstream predictive model on a dataset that combined observed and synthetic data in different proportions. For instance, a dataset with a mixing proportion of (30%, 70%) would be composed of 30% of data sampled from the observed data and 70% of data synthesized by the generative model. We tested the predictive model on the test set sampled from the observed data which had not been seen by the generative model. If the synthetic data resemble the observed data, the predictive power of the downstream model trained on datasets with different mixing proportions should remain similar. Subplot (a) of FIG. 5 shows the results of the TMTR experiment for the one-day forecast on the three assets. The predictive accuracy is remarkably consistent across all mixing proportions, when synthetic data were generated using FTS-Diffusion. In comparison, the predictive accuracy deteriorates (large MAPEs) as the proportion of observed data decreases, when synthetic data were generated by using RCGAN, TimeGAN, or CSDI. Thus, FTS-Diffusion is capable of generating synthetic time series sufficiently similar to actual data to uphold the performance of a downstream prediction task, whereas other models cannot.

TATR. We initialized the training set with limited observed data. We then iteratively appended additional synthetic data and evaluated the resulting performance of the downstream predictive model for a one-day ahead forecast. The results in subplot (b) of FIG. 5 show a clear downward trend in the prediction error as more synthetic data from FTS-Diffusion were added to the training set. Appending 100 years of synthetic data reduces the MAPE by 17.9%, 15.3%, and 17.4% on the three assets, respectively. In contrast, the prediction error either increases or largely remains the same when synthetic data were generated by other baselines. These results indicate that FTS-Diffusion can effectively alleviate the problem of data shortage by augmenting the training set with sufficient synthetic samples.

### 5. Embodiments of Present Disclosure

Embodiments of the present disclosure are developed as follows based on the details, examples, applications, etc. regarding the FTS-Diffusion framework 200 as disclosed above possibly with generalization and extension.

A first aspect of the present disclosure is to provide a first computer-implemented method for synthesizing a synthetic FTS.

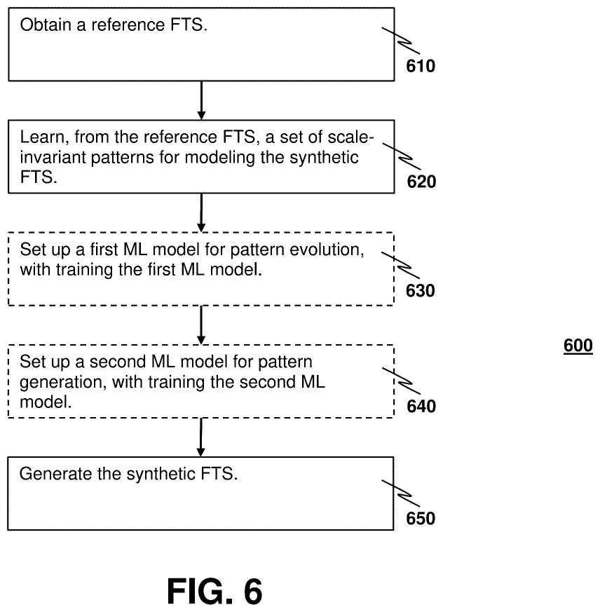

The first method is exemplarily illustrated with the aid of FIG. 6, which depicts a first workflow 600 showing exemplary steps of the first method. The first workflow 600 exemplarily comprises steps 610, 620 and 650.

The step 610 is an initialization step. In the step 610, a reference FTS is obtained.

The step 620 essentially generalizes tasks performed by the pattern recognition module 210 of the framework 200. In the step 620, a set of scale-invariant patterns (i.e. [symbol] ) for modeling the synthetic FTS is learnt from the reference FTS. In particular, the set of scale-invariant patterns is learnt by performing a joint process of segmenting the reference FTS into a first sequence of reference-FTS segments with variable segment lengths and clustering a plurality of normalized segments derived from the first sequence into a plurality of clusters to yield a plurality of cluster centroids. Furthermore, the joint process is performed under a segmentation requirement that a segment length of an individual reference-FTS segment is selected to minimize a distance from a normalized segment corresponding to the individual reference-FTS segment to a nearest centroid in the plurality of cluster centroids. The plurality of normalized segments as mentioned above is obtained via normalizing the individual reference-FTS segment in magnitude and in segment duration. The plurality of cluster centroids as determined in the joint process is used as the plurality of scale-invariant patterns.

The step 650 essentially generalizes tasks performed by the pattern generation module 220 and the pattern evolution module 230 of the framework 200. After the plurality of scale-invariant patterns is identified in the step 620, the synthetic FTS is generated in the step 650 as a second sequence of synthetic-FTS segments with variable segment lengths. In particular, an individual synthetic-FTS segment in the second sequence is generated as a sample 240 of a conditional distribution conditioned on a tuple of parameters associated with the individual synthetic-FTS segment. The tuple of parameters consists of a scale-invariant pattern, a magnitude-scaling factor and a duration-scaling factor. The scale-invariant pattern is selected from the set of scale-invariant patterns, and is used for controlling a waveshape of the generated individual synthetic-FTS segment. The magnitude-scaling factor is used for amplitude-scaling the waveshape in generating the individual synthetic-FTS segment. The duration-scaling factor is used for controlling compression and expansion of the waveshape in time in generating the individual synthetic-FTS segment. That is, the duration-scaling factor controls a time duration of the waveshape in generating the individual synthetic-FTS segment.

In certain embodiments, DTW is used as a distance matric in computing the distance from the normalized segment corresponding to the individual reference-FTS segment to the nearest centroid in the plurality of cluster centroids.

In certain embodiments, the conditional distribution is a multivariate Gaussian distribution.

In certain embodiments, a greedy algorithm is employed in the joint process to jointly determine (1) corresponding segment lengths of respective reference-FTS segments in the first sequence and (2) the plurality of cluster centroids. “A greedy algorithm” is generally considered to be an algorithm that follows the problem-solving heuristic of making the locally optimal choice at each stage. The SISC algorithm 212 as detailed in Section 3.1.1 is one example of the greedy algorithm.

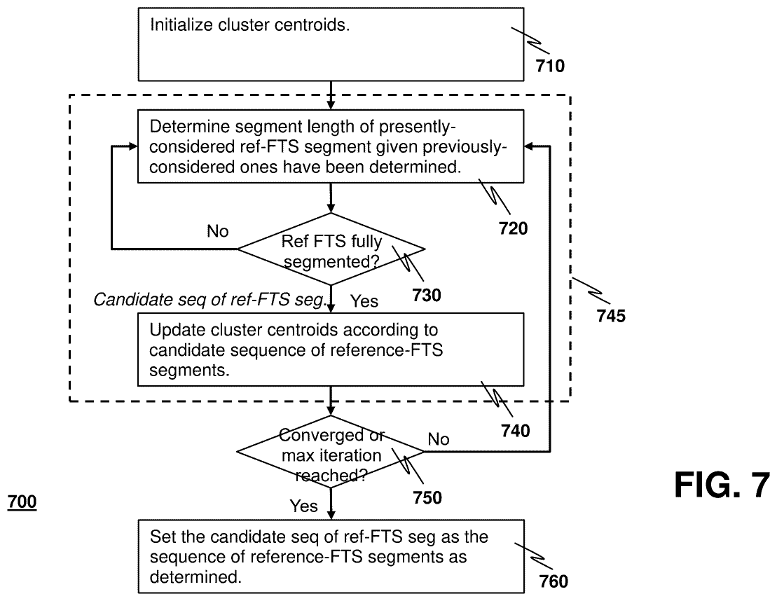

FIG. 7 depicts a second workflow 700 showing exemplary steps of the SISC algorithm 212. In certain embodiments, the greedy algorithm, which is used for jointly determining the corresponding segment lengths and the plurality of cluster centroids, is realized by the second workflow 700. The second workflow 700 comprises steps 710, 730, 750 and 760.

The step 710 is an initialization step. In the step 710, the plurality of cluster centroids is initialized. As mentioned in Section 3.1, respective cluster centroids in the plurality of cluster centroids may be randomly selected in initialization. Alternatively, a more preferable initialization scheme, also disclosed in Section 3.1, may also be used.

In the step 730, a first subprocess 720 is repeated until the reference FTS is fully segmented to form a candidate sequence of reference-FTS segments. The first subprocess 720 is programmed to determine a segment length of a presently-considered reference-FTS segment to fulfill the segmentation requirement given that respective sequence lengths of previously-considered reference-FTS segments have been determined. As mentioned above, the segmentation requirement is that the segment length of the individual reference-FTS segment is selected to minimize the distance from the normalized segment corresponding to the individual reference-FTS segment to a nearest centroid in the plurality of cluster centroids.

After the step 730 is completed, the plurality of cluster centroids is updated in the step 740 according to the candidate sequence of reference-FTS segments.

After the step 740 is completed, the step 750 is executed. In the step 750, a second subprocess 745 working with the updated plurality of cluster centroids is repeated until the candidate sequence of reference-FTS segments as a whole converges or until the second subprocess 745 has been executed for a predetermined number of times. The second subprocess 745 comprises the steps 730 and 740. The predetermined number of times corresponds to max_iters in Algorithm 1.

After the step 750 is completed, the step 760 is executed. In the step 760, setting the candidate sequence of reference-FTS segments as obtained at completion of the step 750 is set to be the first sequence of reference-FTS segments.

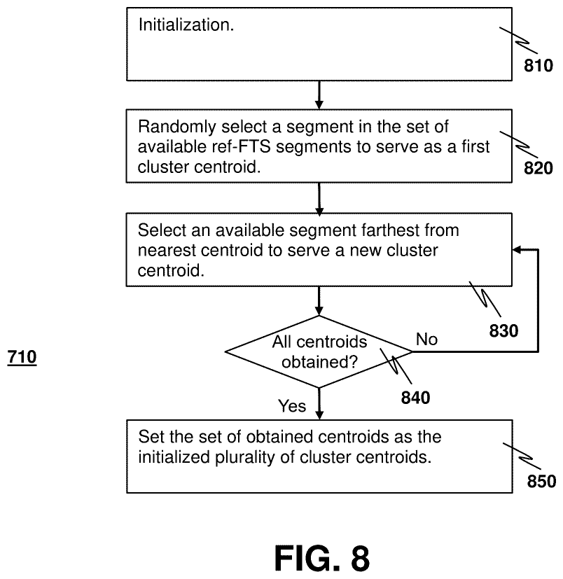

As mentioned above, the step 710 may be realized with the more preferable initialization scheme disclosed in Section 3.1. In certain embodiments, the step 710 is realized with this initialization scheme. FIG. 8 depicts exemplary steps executed by the step 710 in which this initialization scheme is adopted. The step 710 comprises steps 810, 820, 840 and 850.

The step 810, which is an initialization step, initializes a set of available reference-FTS segments and a set of cluster centroids. The set of available reference-FTS segments is initialized such that respective segments in the initialized set of available reference-FTS segments are disjoint segments of the reference FTS and are of equal length. The set of cluster centroids is initialized to be an empty set.

The step 820 is executed when the set of cluster centroids is an empty set. Note that the step 820 is executed after the step 810 is completed. In the step 820, the following tasks are performed: randomly selecting a segment in the set of available reference-FTS segments to serve as a first cluster centroid in the set of cluster centroids; updating the set of cluster centroids with the first cluster centroid; and updating the set of available reference-FTS segments by removing the selected segment that serves the first cluster centroid.

After the step 820 is completed, the step 840 is executed. In the step 840, a third subprocess 830 working with the updated set of cluster centroids and the updated set of available reference-FTS segments is repeated until the set of cluster centroids is filled with a preselected number of cluster centroids. Note that the preselected number of cluster centroids is K. The third subprocess 830 comprises performing the following tasks. In the first task, a segment in the set of available reference-FTS segments is selected to serve as a new cluster centroid in the set of cluster centroids. In this task, a weight of an individual segment in the set of available reference-FTS segments to be selected as the new cluster centroid is proportional to a distance from said individual segment to a closest centroid in the set of cluster centroids. The segment to serve the new cluster centroid is selected according to respective weights computed for the set of available reference-FTS segments. In the second task, the set of cluster centroids is updated with the new cluster centroid. In the third task, the set of available reference-FTS segments is updated by removing the selected segment that serves the new cluster centroid.

After the set of cluster centroids is filled with the preselected number of cluster centroids, the set of cluster centroids is set in the step 850 as the initialized plurality of cluster centroids.

It is preferable and advantageous that the step 650 of generating the synthetic FTS utilizes the ML techniques provided by the pattern generation module 220 and the pattern evolution module 230. Refer to FIG. 6. Preferably, the first workflow 600 further comprises steps 630 and 640.

In the step 630, a first ML model for generating a second tuple of parameters from a first tuple of parameters is set up. Note that the first ML model corresponds to the pattern evolution network ϕ232 in the pattern evolution module 230. Hereinafter the first ML model is also referenced as 232 for convenience. The second tuple of parameters is used for modeling a second synthetic-FTS segment in the second sequence. The first tuple of parameters is used for modeling a first synthetic-FTS segment that immediately precedes the second synthetic-FTS segment in the second sequence. By using the first ML model 232, temporal dynamics of the synthetic FTS are learnt. In setting up the first ML model 232, the first ML model 232 is trained with the reference FTS.

In the step 640, a second ML model is set up. The second ML model is used for generating the individual synthetic-FTS segment in the second sequence according to an input tuple of parameters. Note that the second ML model corresponds to the ML model θ 222 of the pattern generation module 220. Hereinafter the second ML model is also referenced as 222 for convenience. In setting up the second ML model 222, the second ML model 222 is trained with the first sequence.

Both of the steps 630 and 640 are executed before the step 650 is carried out. Furthermore, the step 650 comprises recursively using the first and second ML models 222, 232 to generate consecutive synthetic-FTS segments for the second sequence.

In initiating execution of the step 650, the consecutive synthetic-FTS segments have not been generated and the step 650 proceeds to generate an initial segment. Specifically, the initial segment among the consecutive synthetic-FTS segment is generated by the second ML model 222 with an initial tuple of parameters used as the input tuple of parameters.

In certain embodiments, the initial tuple of parameters is externally received from outside the first and second ML models 222, 232. It follows that a fresh new synthetic FTS is generated, and it is not intended that the synthetic FTS so generated overlaps with other FTS such as the reference FTS.

In certain embodiments, the initial tuple of parameters is generated from the first ML model 232. It implies that that the first tuple of parameters used by the first ML model 232 in generating the initial tuple of parameters is externally received from outside the first and second ML models 222, 232. It also implies that the segment immediately before the initial segment is known. The synthetic FTS synthesized by the first workflow 600 is intended to be a continuation of a certain FTS. The aforementioned certain FTS may simply be the reference FTS or may be another time series.

In certain embodiments, the second ML model 222 comprises a scaling AE 321 and a pattern-conditioned diffusion network 322. The scaling AE 321 comprises an encoder 325 and a decoder 326. The encoder 325 is used for transforming a first variable-length segment into a first fixed-length segment. The decoder 326 is used for transforming a second fixed-length segment from a second variable-length segment. The first variable-length segment is computed according to the input tuple of parameters. The second variable-length segment is used as one synthetic-FTS segment in the second sequence. Furthermore, the scaling AE 321 is trained according to the reference FTS and the set of scale-invariant patterns. The pattern-conditioned diffusion network 322, which is a diffusion-based generative network conditioned on a pattern, is used for generating the second fixed-length segment from the first fixed-length segment.

In certain embodiments, the pattern-conditioned diffusion network 322 is realized according to a DDPM.

Various practical applications based on the FTS-Diffusion framework 200 are developed as follows.

A second aspect of the present disclosure is to provide a second computer-implemented method for testing a financial computing system. In particular, the second method utilizes the first method to synthesize a plurality of synthetic FTS for testing the financial computing system.

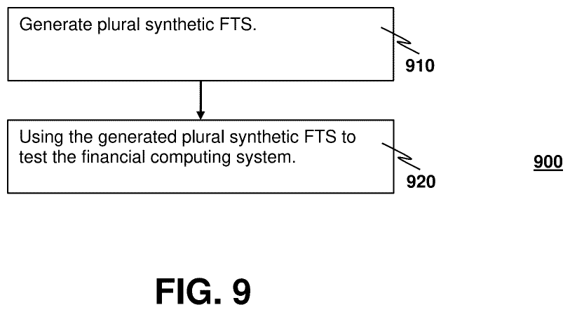

FIG. 9 depicts a third workflow 900 showing exemplary steps of the second method. The third workflow 900 exemplarily comprises steps 910 and 920. In the step 910, plural synthetic FTS are each generated according to an appropriate embodiment of the first method (i.e. generated by performing the first workflow 600). In the step 920, the financial computing system is tested under testing conditions respectively defined by the generated plural synthetic FTS.

In a first option of the step 910, the plural synthetic FTS are generated by a first appropriate embodiment of the first method with plural reference FTS that are mutually-different, respectively. As a result, the plural synthetic FTS are likely to be mutually dissimilar in waveshape. A rich variety of synthetic FTS is hence generated. The generated plural synthetic FTS may be used to test, e.g., robustness of the financial computing system under different kinds of attacks.

In a second option of the step 910, the plural synthetic FTS are generated by a second appropriate embodiment of the first method under one reference FTS with plural initial tuples of parameters that are mutually-different, respectively. Thus, the plural synthetic FTS are likely to have similar (normalized) waveshapes. In case each synthetic FTS represents a certain amount of loading to the financial computing system, the generated plural synthetic FTS may be used to test, e.g., resilience of the financial computing system under different degrees of work loading.

Other options of the step 910 are also possible.

Third and fourth aspects of the present disclosure are to provide a third computer-implemented method for predicting a stock price and a fourth computer-implemented method for automatically trading a stock, respectively. Automatic trading of a stock means machine-initiated trading of the stock without human intervention.

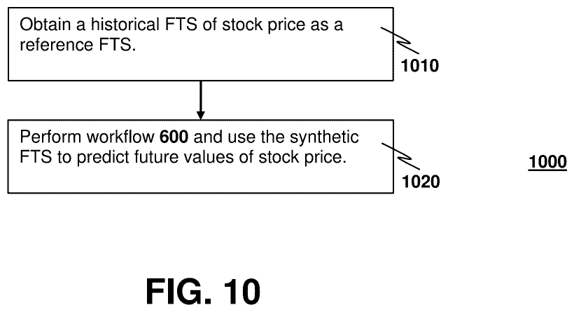

Exemplarily, the third method is elaborated with the aid of FIG. 10, which depicts a fourth workflow 1000 showing exemplary steps of predicting the stock price.

In step 1010, a historical FTS is obtained. The historical FTS is a time series recording historical values of the stock price over a certain duration of time.

After the historical FTS is obtained, future values of the stock price are predicted in step 1020 according to a synthetic FTS synthesized by an appropriate embodiment of the first method with the historical FTS being used as the reference FTS. In executing the appropriate embodiment of the first method, furthermore, the initial tuple of parameters as used by the second ML model is generated as a corresponding second tuple of parameters by the first ML model with a corresponding first tuple of parameters. The corresponding first tuple of parameters is a tuple of parameters associated with a last reference-FTS segment in the first sequence such that the synthetic FTS is a predicted continuation of the reference FTS (i.e. the historical FTS of the stock price).

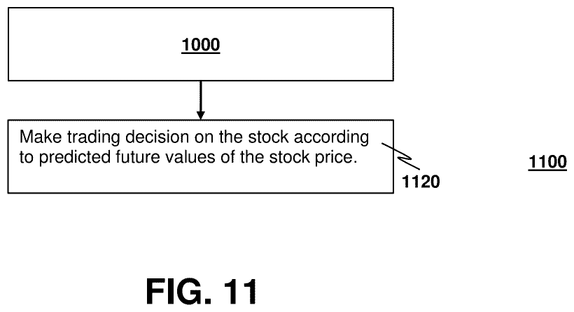

The fourth workflow 1000 is extensible to realize automatic trading of a stock. FIG. 11 depicts a fifth workflow 1100 showing exemplary steps for realizing the fourth method for automatically trading a stock. In the fifth workflow 1100, future values of a stock price of the stock are first predicted by executing the fourth workflow 1000. In step 1120, a trading decision on the stock according to the predicted future values of the stock price. Those skilled in the art will appreciate that one may develop a set of go/no-go trading-decision rules based on determining certain properties of the predicted future values of the stock price, e.g., presence of short-term downward trend in the predicted future stock values.

The present disclosure may be embodied in other specific forms without departing from the spirit or essential characteristics thereof. The present embodiment is therefore to be considered in all respects as illustrative and not restrictive. The scope of the invention is indicated by the appended claims rather than by the foregoing description, and all changes that come within the meaning and range of equivalency of the claims are therefore intended to be embraced therein.

### REFERENCES

There follows a list of references that are occasionally cited in the specification. Each of the disclosures of these references is incorporated by reference herein in its entirety.
Jushan Bai and Peng Wang. Conditional Markov chain and its application in economic time series analysis. Journal of applied econometrics, 26(5):715-734, 2011.
Nicholas Barberis and Andrei Shleifer. Style investing. Journal of financial Economics, 68(2): 161-199, 2003.
Eoin Brophy. Synthesis of dependent multichannel ECG using generative adversarial networks. In Proceedings of the 29th ACM international conference on information & knowledge management, pp. 3229-3232, 2020.
Yize Chen, Yishen Wang, Daniel Kirschen, and Baosen Zhang. Model-free renewable scenario generation using generative adversarial networks. IEEE Transactions on Power Systems, 33(3): 3265-3275, 2018.
Rama Cont. Empirical properties of asset returns: stylized facts and statistical issues. Quantitative finance, 1(2):223, 2001.
Abhyuday Desai, Cynthia Freeman, Zuhui Wang, and Ian Beaver. TimeVAE: A variational auto-encoder for multivariate time series generation. arXiv preprint arXiv:2111.08095, 2021.
Prafulla Dhariwal and Alexander Nichol. Diffusion models beat GANs on image synthesis. Advances in Neural Information Processing Systems, 34:8780-8794, 2021.
Michael J Dueker. Markov switching in GARCH processes and mean-reverting stock-market volatility. Journal of Business & Economic Statistics, 15(1):26-34, 1997.
Cristóbal Esteban, Stephanie L Hyland, and Gunnar Rätsch. Real-valued (medical) time series generation with recurrent conditional GANs. arXiv preprint arXiv:1706.02633, 2017.
Ian J Goodfellow, Jean Pouget-Abadie, Mehdi Mirza, Bing Xu, David Warde-Farley, Sherjil Ozair, Aaron C Courville, and Yoshua Bengio. Generative adversarial nets. In NIPS, 2014.
John A Hartigan and Manchek A Wong. Algorithm AS 136: A K-means clustering algorithm. Journal of the royal statistical society. series c (applied statistics), 28(1):100-108, 1979.
Jonathan Ho, Ajay Jain, and Pieter Abbeel. Denoising diffusion probabilistic models. Advances in Neural Information Processing Systems, 33:6840-6851, 2020.
Xin Huang and Duan Li. A two-level reinforcement learning algorithm for ambiguous mean-variance portfolio selection problem. In Proceedings of the Twenty-Ninth International Conference on International Joint Conferences on Artificial Intelligence, pp. 4527-4533, 2021.
Jinsung Jeon, Jeonghak Kim, Haryong Song, Seunghyeon Cho, and Noseong Park. GT-GAN: General purpose time series synthesis with generative adversarial networks. Advances in Neural Information Processing Systems, 35:36999-37010, 2022.
James Jordon, Jinsung Yoon, and Mihaela Van Der Schaar. PATE-GAN: Generating synthetic data with differential privacy guarantees. In International conference on learning representations, 2018.
Zhifeng Kong, Wei Ping, Jiaji Huang, Kexin Zhao, and Bryan Catanzaro. Diffwave: A versatile diffusion model for audio synthesis. In International Conference on Learning Representations, 2021. URL https://openreview.net/forum?id=a-xFK8Ymz5J.
Yichong Leng, Zehua Chen, Junliang Guo, Haohe Liu, Jiawei Chen, Xu Tan, Danilo Mandic, Lei He, Xiangyang Li, Tao Qin, et al. Binauralgrad: A two-stage conditional diffusion probabilistic model for binaural audio synthesis. Advances in Neural Information Processing Systems, 35: 23689-23700, 2022.
Andrew W Lo, Harry Mamaysky, and Jiang Wang. Foundations of technical analysis: Computational algorithms, statistical inference, and empirical implementation. The journal of finance, 55(4): 1705-1765, 2000.
Gerardo Manzo and Xiao Qiao. Deep learning credit risk modeling. Forthcoming Journal of Fixed Income, 2020.
Yao Qin, Dongjin Song, Haifeng Cheng, Wei Cheng, Guofei Jiang, and Garrison W Cottrell. A dual-stage attention-based recurrent neural network for time series prediction. In Proceedings of the 26th International Joint Conference on Artificial Intelligence, pp. 2627-2633, 2017.
Carl Remlinger, Joseph Mikael, and Romuald Elie. Conditional loss and deep Euler scheme for time series generation. In Proceedings of the AAAI Conference on Artificial Intelligence, volume 36, pp. 8098-8105, 2022.
Poonam Somani, Shreyas Talele, and Suraj Sawant. Stock market prediction using hidden Markov model. In 2014 IEEE 7th joint international information technology and artificial intelligence conference, pp. 89-92. IEEE, 2014.
Yusuke Tashiro, Jiaming Song, Yang Song, and Stefano Ermon. CSDI: Conditional score-based diffusion models for probabilistic time series imputation. Advances in Neural Information Processing Systems, 34:24804-24816, 2021.
Robert L Thorndike. Who belongs in the family? Psychometrika, 18(4):267-276, 1953.
Gefei Wang, Yuling Jiao, Qian Xu, Yang Wang, and Can Yang. Deep generative learning via Schradinger bridge. In International Conference on Machine Learning, pp. 10794-10804. PMLR, 2021.
Magnus Wiese, Robert Knobloch, Ralf Korn, and Peter Kretschmer. Quant GANs: Deep generation of financial time series. Quantitative Finance, 20(9):1419-1440, 2020.
Hanwei Wu, Ather Gattami, and Markus Flierl. Conditional mutual information-based contrastive loss for financial time series forecasting. In Proceedings of the First ACM International Conference on AI in Finance, pp. 1-7, 2020.
Yumo Xu and Shay B Cohen. Stock movement prediction from tweets and historical prices. In Proceedings of the 56th Annual Meeting of the Association for Computational Linguistics (Volume 1: Long Papers), pp. 1970-1979, 2018.
Jinsung Yoon, Daniel Jarrett, and Mihaela van der Schaar. Time-series generative adversarial networks. In Proceedings of the 33rd International Conference on Neural Information Processing Systems, pp. 5508-5518, 2019.
Houssam Zenati, Manon Romain, Chuan-Sheng Foo, Bruno Lecouat, and Vijay Chandrasekhar. Adversarially learned anomaly detection. In 2018 IEEE International conference on data mining (ICDM), pp. 727-736. IEEE, 2018.
Chi Zhang, Sanmukh R Kuppannagari, Rajgopal Kannan, and Viktor K Prasanna. Generative adversarial network for synthetic time series data generation in smart grids. In 2018 IEEE International Conference on Communications, Control, and Computing Technologies for Smart Grids (SmartGridComm), pp. 1-6. IEEE, 2018.

What is claimed is:

1. A computer-implemented method for synthesizing a synthetic financial time series (FTS), the method comprising:
obtaining a reference FTS;
learning, from the reference FTS, a set of scale-invariant patterns for modeling the synthetic FTS by performing a joint process of segmenting the reference FTS into a first sequence of reference-FTS segments with variable segment lengths and clustering a plurality of normalized segments derived from the first sequence into a plurality of clusters to yield a plurality of cluster centroids under a segmentation requirement that a segment length of an individual reference-FTS segment is selected to minimize a distance from a normalized segment corresponding to the individual reference-FTS segment to a nearest centroid in the plurality of cluster centroids, wherein the plurality of normalized segments is obtained via normalizing the individual reference-FTS segment in magnitude and in segment duration, and wherein the plurality of cluster centroids is used as the plurality of scale-invariant patterns; and
generating the synthetic FTS as a second sequence of synthetic-FTS segments with variable segment lengths, wherein an individual synthetic-FTS segment is generated as a sample of a conditional distribution conditioned on a tuple of parameters associated with the individual synthetic-FTS segment, and wherein the tuple of parameters consists of a scale-invariant pattern selected from the set of scale-invariant patterns for controlling a waveshape of the generated individual synthetic-FTS segment, a magnitude-scaling factor for amplitude-scaling the waveshape in generating the individual synthetic-FTS segment, and a duration-scaling factor for controlling compression and expansion of the waveshape in time in generating the individual synthetic-FTS segment.

2. The method of claim 1, wherein a greedy algorithm is employed in the joint process to jointly determine corresponding segment lengths of respective reference-FTS segments in the first sequence, and the plurality of cluster centroids.

3. The method of claim 2, wherein the greedy algorithm comprises the steps of:
(a) initializing the plurality of cluster centroids;
(b) repeating a first subprocess until the reference FTS is fully segmented to form a candidate sequence of reference-FTS segments, wherein the first subprocess is programmed to determine a segment length of a presently-considered reference-FTS segment to fulfill the segmentation requirement given that respective sequence lengths of previously-considered reference-FTS segments have been determined;
(c) after the step (b) is completed, updating the plurality of cluster centroids according to the candidate sequence of reference-FTS segments;
(d) repeating a second subprocess with the updated plurality of cluster centroids until the candidate sequence of reference-FTS segments as a whole converges or until the second subprocess has been executed for a predetermined number of times, wherein the second subprocess comprises the steps (b) and (c); and
(e) setting the candidate sequence of reference-FTS segments as obtained at completion of the step (d) to be the first sequence of reference-FTS segments.

4. The method of claim 3, wherein the step (a) comprises:
initializing a set of available reference-FTS segments, wherein respective segments in the initialized set of available reference-FTS segments are disjoint segments of the reference FTS and are of equal length;
initializing a set of cluster centroids to be an empty set;
when the set of cluster centroids is empty:
randomly selecting a segment in the set of available reference-FTS segments to serve as a first cluster centroid in the set of cluster centroids;
updating the set of cluster centroids with the first cluster centroid; and
updating the set of available reference-FTS segments by removing the selected segment that serves the first cluster centroid;
repeating a third subprocess with the updated set of cluster centroids and the updated set of available reference-FTS segments until the set of cluster centroids is filled with a preselected number of cluster centroids, wherein the third subprocess comprises:
selecting a segment in the set of available reference-FTS segments to serve as a new cluster centroid in the set of cluster centroids, wherein a weight of an individual segment in the set of available reference-FTS segments to be selected as the new cluster centroid is proportional to a distance from said individual segment to a closest centroid in the set of cluster centroids, and wherein the segment to serve the new cluster centroid is selected according to respective weights computed for the set of available reference-FTS segments;
updating the set of cluster centroids with the new cluster centroid; and
updating the set of available reference-FTS segments by removing the selected segment that serves the new cluster centroid; and
after the set of cluster centroids is filled with the preselected number of cluster centroids, setting the set of cluster centroids as the initialized plurality of cluster centroids.

5. The method of claim 1, wherein dynamic time wrapping (DTW) is used as a distance matric in computing the distance from the normalized segment corresponding to the individual reference-FTS segment to the nearest centroid in the plurality of cluster centroids.

6. The method of claim 1, wherein the conditional distribution is a multivariate Gaussian distribution.

7. The method of claim 1 further comprising:
before the synthetic FTS is generated, setting up a first machine-learning (ML) model for generating a second tuple of parameters used for modeling a second synthetic-FTS segment in the second sequence from a first tuple of parameters used for modeling a first synthetic-FTS segment that immediately precedes the second synthetic-FTS segment in the second sequence such that temporal dynamics of the synthetic FTS are learnt, wherein the first ML model is trained with the reference FTS; and
before the synthetic FTS is generated, setting up a second ML model for generating the individual synthetic-FTS segment in the second sequence according to an input tuple of parameters, wherein the second ML model is trained with the first sequence;
wherein the generating of the synthetic FTS as the second sequence of synthetic-FTS segments with variable segment lengths comprises recursively using the first and second ML models to generate consecutive synthetic-FTS segments for the second sequence.

8. The method of claim 7, wherein an initial segment among the consecutive synthetic-FTS segment is generated by the second ML model with an initial tuple of parameters used as the input tuple of parameters, the initial tuple of parameters being generated from the first ML model.

9. The method of claim 7, wherein an initial segment among the consecutive synthetic-FTS segment is generated by the second ML model with an initial tuple of parameters used as the input tuple of parameters, the initial tuple of parameters being externally received from outside the first and second ML models.

10. The method of claim 7, wherein the second ML model comprises:
a scaling autoencoder (AE) comprising an encoder for transforming a first variable-length segment into a first fixed-length segment, and a decoder for transforming a second fixed-length segment from a second variable-length segment, wherein the first variable-length segment is computed according to the input tuple of parameters, wherein the second variable-length segment is used as one synthetic-FTS segment in the second sequence, and wherein the scaling AE is trained according to the reference FTS and the set of scale-invariant patterns; and
a pattern-conditioned diffusion network for generating the second fixed-length segment from the first fixed-length segment.

11. The method of claim 10, wherein the pattern-conditioned diffusion network is realized according to a denoising diffusion probabilistic model (DDPM).

12. A computer-implemented method for testing a financial computing system, the method comprising:
generating plural synthetic financial time series (FTS) according to the method of claim 1 with plural reference FTS that are mutually-different, respectively; and
testing the financial computing system under testing conditions respectively defined by the plural synthetic FTS.

13. A computer-implemented method for testing a financial computing system, the method comprising:
generating plural synthetic financial time series (FTS) according to the method of claim 9 under one reference FTS with plural initial tuples of parameters that are mutually-different, respectively; and
testing the financial computing system under testing conditions respectively defined by the plural synthetic FTS.

14. A computer-implemented method for predicting a stock price, the method comprising:
obtaining a historical financial time series (FTS), the historical FTS being a time series recording historical values of the stock price over a certain duration of time; and
predicting future values of the stock price by a synthetic FTS synthesized by the method of claim 8 with the historical FTS being used as the reference FTS, wherein the initial tuple of parameters is generated as a corresponding second tuple of parameters by the first ML model with a corresponding first tuple of parameters, the corresponding first tuple of parameters being a tuple of parameters associated with a last reference-FTS segment in the first sequence such that the synthetic FTS is a predicted continuation of the reference FTS.

15. A computer-implemented method for automatically trading a stock, the method comprising:
predicting future values of a stock price of the stock by the method of claim 14; and
automatically making a trading decision on the stock according to the future values of the stock price.
